(19) United States
(12) Patent Application Publication
(10) Pub. No.: US 2004/0098601 A1
(43) Pub. Date: May 20, 2004

(54) Secure local copy protection

(76) Inventor: Michael A. Epstein, Spring Valley, NY (US)

Correspondence Address: PHILIPS ELECTRONICS NORTH AMERICAN CORP, 580 WHITE PLAINS RD, TARRYTOWN, NY, 10591, US

(21) Appl. No.: 10/294,532

(22) Filed: Nov. 14, 2002

(51) Int. Cl. G06F 12/14

(52) U.S. Cl. 713/193; 380/201

(57) ABSTRACT

A rendering and copying system and method isolates the ‘clear’ form of the content material from access by a software program running on a processing device. The rendering and copying of content material in clear form is effected via a device that is not accessible by the processing device that provides the user interface or other program functions associated with the rendering and copying of the content material. In a preferred embodiment, the media-access device, such as a CD or DVD recorder in a personal computer, is configured to effect the rendering and copying functions, under the control of the processing device of the personal computer, but without communicating the content material in clear form to the memory that is accessible to the processing device.

### BACKGROUND OF THE INVENTION

1. Field of the Invention

This invention relates to the field of copy protection, and in particular to the prevention of unauthorized distribution of copy-protected material via a computer network, such as the Internet.

2. Description of Related Art

The advances in computer communications have enabled unprecedented data transfer opportunities. Unfortunately, these advances have also enabled unprecedented opportunities for unauthorized data transfers. Anyone with access to a computer can transmit a virtually limitless number of copies of recorded material, even if the material is prohibited by law from being copied without permission. Typically, the material is recorded in digital form, and the distribution of copies of this digitally recorded material allows for copies of the material that are of the same quality as the original material.

A variety of copy-protection schemes have been proposed for preventing the unauthorized distribution of copy-protected material. These schemes face a set of conflicting requirements: a user should be able to make copies of copy-protected material for his or her own use, and should not be able to distribute copies to other users.

Copy-protection schemes generally fall within one of two categories: preventing the copying or transmission of copy-protected material, and preventing the rendering of unauthorized copy-protected material. The prevention of rendering of unauthorized copy-protected material relies upon the use of “compliant” playback devices that are configured to enforce the prevention, and include, for example, systems that detect whether the material had been compressed for transmission.

The prevention of the copying or transmission of copy-protected material generally includes an encryption of the content material, so that, even if the encrypted material is copied and/or transmitted, it cannot be rendered without a corresponding decryption key. These techniques rely upon a “compliant” system that prevents the disclosure of the decryption key.

In a typical copy and/or transmission system, such as a personal computer coupled to the Internet, the content material is, at some point, available in “clear”, or unencrypted, form, and it is at this point that the material is most vulnerable to illicit copying. Even though the program that is used to process the material may be configured to prevent access to the material in clear form, a rogue program can be developed to work-around the prevention scheme.

### BRIEF SUMMARY OF THE INVENTION

It is an object of this invention to provide a method and system for securing copy-protected material from unauthorized distribution via a computer network. It is a further object of this invention to prevent access to copy-protected material in an unprotected form.

These objects and others are achieved by providing a method and system for rendering and copying content material that isolates the ‘clear’ form of the content material from access by a software program running on a processing system. The rendering and copying of content material in clear form is effected via a media-access device that is not accessible by the processing device that provides the user interface or other program functions associated with the rendering and copying of the content material. In a preferred embodiment, the media-access device, such as a CD or DVD recorder in a personal computer, is configured to effect the rendering and copying functions, under the control of the processing device of the personal computer, but without communicating the content material in clear form to the memory that is accessible to the processing device.

### BRIEF DESCRIPTION OF THE DRAWINGS

The invention is explained in further detail, and by way of example, with reference to the accompanying drawings wherein:

FIG. 1 illustrates an example block diagram of a copy-protection system in accordance with this invention.

Throughout the drawings, the same reference numerals indicate similar or corresponding features or functions.

### DETAILED DESCRIPTION OF THE INVENTION

This invention is premised on the observation that providing unauthorized copies of copy-protected material via electronic means has the potential of causing substantially more financial harm to the owner of the copy-protected material than providing unauthorized copies via physical media. As such, the conflicting requirements of allowing a user to copy material for his or her personal use while preventing the user from distributing the material to others can be satisfied, to a substantial degree, by allowing the user to make physical copies of the material but preventing the user from making renderable electronic copies of the material.

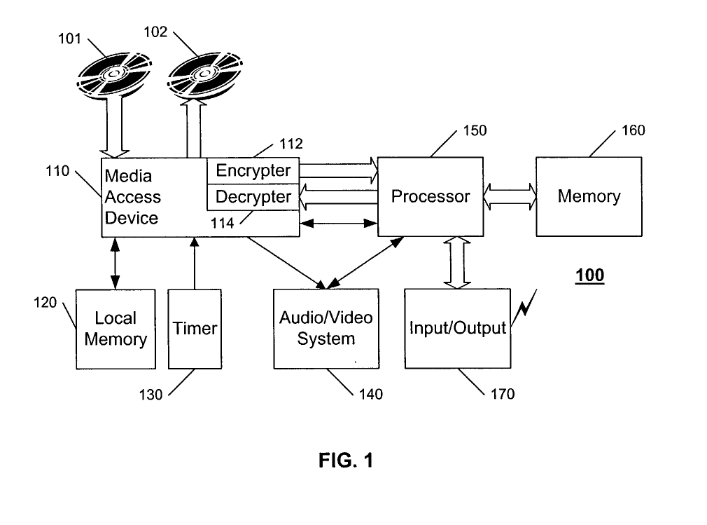

FIG. 1 illustrates an example block diagram of a copy-protection system 100 in accordance with this invention. The system 100 includes a media-access device 110, such as a CD or DVD reader/recorder, that is configured to read from and/or write to physical media 101, 102. As in a conventional system, the media-access device 110 is accessible by a processor 150 that is coupled to one or more input or output components 170, including a potential communications path to other computer networks, such as the Internet.

In accordance with this invention, the media-access device 110 is configured to communicate the content material from the media 101 to the processor 150 in a secure form. In a preferred embodiment of this invention, the material is encrypted via an encrypter 112 within the device 110, using a key that is known only to the device 110. The secured material may be stored in the memory 160 that is associated with the processor 150, for subsequent use by the device 110. The device 110 decrypts the secured material that is provided from the processor 150, via a decrypter 114, again using a key that is known only to the device 110.

Because the material is secured before it enters the realm of the processor 150, even if a copy of this material is transmitted to others, via the input/output components 170, it will be unusable, because only the device 110 has access to the key that is necessary to decrypt the material. On the other hand, because the material is decrypted by the decrypter 114 when it enters the media-access device 110 from the realm of the processor, the media-access device 110 is able to make ‘clear’ copies of the material on physical media 102.

The advantages of this invention are best understood in the context of a typical use of the invention, as follows.

Assume that a user desires to make a copy of one or more selections from a physical media 101 onto another physical media 102, using an application program that is modeled after conventional disc-copying or disc-composing application programs. The application program, for example, provides the user with the convenience of identifying each selection by merely clicking on a ‘check box’ that is associated with the title of the selection, or by ‘grabbing’ one or more titles from a list of titles and moving the grabbed titles to an icon that corresponds to the media 102, and so on.

As in a conventional disc-composing application, the selected material from the media 101 will generally be read into the memory 160 as blocks of data, then written out to the media 102, also in block form, to allow for efficient read and write operations, and also to allow the material to be copied via a single-drive media-access device 110, such as a typical CD-recorder in a personal computer. In accordance with this invention, the material that is read from the media 102 is encrypted by the encrypter 112 before it is stored in the memory 160, and is decrypted by the decrypter 114 before it is written to the media 102. In this manner, only securely encrypted material is available to the memory 160 or the input/output components 170. Although the data path of the material is indicated as traveling through the processor 150 between the device 110 and the memory 160, one of ordinary skill in the art will recognize that the principles of this invention are equally applicable to direct-memory-access (DMA) operations that bypass the processor 150.

Also illustrated in FIG. 1 are a local memory 120, and a timer 130. The local memory 120 is used to buffer the content material as it is encrypted or decrypted, and may optionally be used for disc-copying operations that do not require the processing or buffering that is provided by the processor 150 or memory 160. For example, if the media-access device 110 is a dual-drive system, the media-access device 110 may be configured to provide a ‘stand-alone’ duplication function, wherein the contents of media 101 are copied directly to the media 102.

The timer 130 is optionally used to provide a time-limit to the authorization of access to the secured material in the memory 160, thereby further increasing the security of the system. In this optional embodiment, the media-access device 110 creates a new encryption/decryption key during each copy session, based on the contents of the timer 130 at the start of the session. After a predetermined authorization-duration, the encryption/decryption key is destroyed and/or replaced by a new encryption/decryption key that is based on the time of the lapse of the authorization-duration. To further provide security, the timer 130 is preferably configured to keep ‘relative’ time, rather than ‘absolute’ time, and may, for example, be configured to operate only when the media-access device 110 is powered, thereby introducing a degree of unpredictability to the contents of the timer 130, and assuring an extremely low-likelihood of two devices having the same key.

An optional audio/video system 140 is illustrated in FIG. 1 that is configured to effect the rendering of the content material from the media-access device 110. Of note, the information that is presented to the audio/video system 140 is preferably the analog or ‘decoded’ form of the content material that drives the audio amplifiers and/or video display devices that are used to render the material. Although this information may be accessible within the realm of the processor 150, it is not in a form that is suitable for transmission to others, and a copy of this information will generally be of lesser quality than the original, thereby minimizing its suitability for electronic-distribution.

In an alternative embodiment of this invention, the key that is used by the media-access device 110 is a private key of a public-private key pair. In this embodiment, encrypted content material may be received by the input/output components 170 from a remote source, for decryption by the media-access device 110. The remote source may be another device of the user, or it may be a commercial web-site that is authorized to distribute copies of the copy-protected content material, or it may be another source of the copy-protected content material. The remote source encrypts the content material using the public-key that is associated with the media-access device 110, and the decrypter 114 of the media-access device 110 uses the corresponding private-key to decrypt the encrypted content material.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. A copy-protection system comprising:
a media-access device that is configured to read content material from a physical media, and to encrypt the content material to provide therefrom encrypted content material,
a processor, operably coupled to the media-access device, that is configured to facilitate control of the media-access device, and
a memory, operably coupled to the processor, that is configured to receive the encrypted content material,
wherein
the media-access device is configured to prevent access to the content material by the processor.

2. The copy-protection system of claim 1, wherein
the media-access device is further configured to decrypt the encrypted content material from the memory to provide therefrom a copy of the content material to facilitate transfer of the copy of the content material to another physical media.

3. The copy-protection system of claim 1, wherein
the media-access device encrypts the content material based on an encryption key that is only accessible by the media-access device.

4. The copy-protection system of claim 3, wherein
the media-access device is further configured to decrypt the encrypted content material from the memory to provide therefrom a copy of the content material to facilitate transfer of the copy of the content material to another physical media.

5. The copy-protection system of claim 3, wherein
the media-access device is further configured to decrypt the encrypted content material from the memory, based on a decryption key, to provide therefrom a copy of the content material to facilitate transfer of the copy of the content material to another physical media, and
the decryption key is also based on the contents of the timer, and is configured to correspond to the encryption key for a predetermined decryption-authorization period.

6. The copy-protection system of claim 3, wherein
the encryption key is based on contents of a timer.

7. The copy-protection system of claim 6, wherein
the contents of the timer are based on at least one of:
a relative time-base,
a random time-base, and
a duration of operational time of the media-access device.

8. A copy-protection system comprising
a processing system that is configured to receive encrypted content material, and
a media-access device that is configured to decrypt the encrypted content material to provide therefrom unencrypted content material and to store the unencrypted content material on a physical media,
wherein
the media-access device is further configured to prevent access to the unencrypted content material by the processing system.

9. The copy-protection system of claim 8, wherein
the encrypted content material is provided by a source that is remote from the copy-protection system, and is encrypted using a public key that is associated with the media-access device.

10. The copy-protection system of claim 8, wherein
the media-access device is further configured to encrypt content material from an other physical media to provide therefrom other encrypted content material that is provided to the processing system, and
the media-access device is further configured to prevent access to the content material from the other physical media by the processing system.

11. A method of protecting content material, comprising:
allowing copies of the content material to be made on physical media, while
preventing copies of the content material to be transmitted in electronic form.

12. The method of claim 11, wherein
preventing copies of the content material to be transmitted in electronic form includes
encrypting the content material to provide encrypted content material,
providing the encrypted content material to a processing system that is configured to facilitate transmission of data in electronic form, and
preventing decryption of the encrypted content material by the processing system.

13. The method of claim 12, wherein
allowing copies of the content material to be made on physical media includes
receiving the encrypted content material from the processing system,
decrypting the encrypted content material to provide a copy of the content material, and
storing the copy of the content material on the physical media.

14. The method of claim 11, wherein
allowing copies of the content material to be made on physical media includes
receiving encrypted content material from a remote source,
decrypting the encrypted content material to provide a copy of the content material, and
storing the copy of the content material on the physical media.
